(19) United States
(12) Patent Application Publication
(10) Pub. No.: US 2004/0117243 A1
(43) Pub. Date: Jun. 17, 2004

(54) Method and system for merchandising management

(76) Inventor: Anthony Chepil (Tony), Richmond Hill (CA)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/413,842

(22) Filed: Apr. 15, 2003

Related U.S. Application Data
(60) Provisional application No. 60/372,883, filed on Apr. 15, 2002.

(51) Int. Cl. G06F 17/60

(52) U.S. Cl. 705/11

(57) ABSTRACT

A method and system for merchandising management and for managing performance in a retail store. The present invention combines a method and system of checking, assessing and determining performance levels with a method of communicating expectation to employees and store management. Methods are adapted to bi-direction voice communication in which questions relative to performance expectations are transmitted from a base computer to an assessor using a remote speaker/microphone unit, the responses of the assessor being transmitted back to the base computer.

The voice computing apparatus, combined with the systems of checking and assessing current levels is capable of performing computerized functions such as ordering inventory. These computerized functions further aid merchandise management within a retail environment.

### RELATED APPLICATION

The present application is related to and claims the benefit under 35 USC §119(e) of priority from U.S. provisional application Ser. No. 60/372,883 filed Apr. 15, 2002, the disclosure of which is hereby incorporated by reference.

### FIELD OF THE INVENTION

This invention relates to methods of managing the performance of employees in a retail stores and identifying the opportunities for improvement in merchandise management in order to facilitate an increase in retail sales.

### BACKGROUND OF THE INVENTION

Retailing is an industry in which thousands of small tasks must be performed in timely manner. The industry struggles with implementing these tasks such as planogramming products and re-stocking products, maintaining product pricing, implementing marketing programs. Any deficiencies in the execution of these tasks will cause a retailer to lose potential sales of their customers who patronize their store. Part of the problem is that most of retailers' workforce is made up of high turnover unskilled staffers earning little more than minimum wage. The other part of the problem is that retailers have not developed an effective method of managing the performance of these employees. Current methods of delegation and follow-up are ineffective. As well, performance measurement is made more difficult due to the large number of tasks that the retailers are required to be performed on a regular and timely basis, such as stocking shelves, changing prices etc.

In conventional retailing, the most common method of delegation and follow-up currently used is a store walk-around. The store manager walks around the store, with pen and paper, viewing the retail displays, signage, stock levels, and general appearance and cleanliness of the store. The store manager generates a task to be completed based upon his/her observations. The problem with this method is it relies on the management person's ability to notice deficiencies and produce this “things to do list” and is therefore prone to inconsistent performance by the management person. This method is also undesirable because it is a reactionary approach rather then a proactive approach to merchandising management and managing performance. A more effective methods of delegation and follow-up which is sometime used, would involve scheduling routine tasks, such as fill the shelves, place P.O.P. (“Point of Purchase”) material or signage for example and then use this schedule as a checklist to follow-up on performance. Some of the problems with this method of delegation and follow-up is that it is time consumptive, burdensome and therefore expensive to undertake consistently and comprehensively: the larger the retail facility, the larger the number of task to be performed, and the more difficult it is to keep up with the merchandising tasks and in tracking performance.

Another important element of retail management that is currently lacking in today's retail environment is the ability to measure performance of such a large number of tasks. Performance measurement allows the merchandise/store managers to determine if current efforts are causing a progression or digression in workforce performance. The merchandise or store manager can then take better control of the situation with this informed to make the appropriate changes.

There is therefore a need in the retail industry for an effective method of merchandising management and managing and measuring performance.

### SUMMARY OF THE INVENTION

This invention relates in a first aspect to a method for merchandise management for a plurality of merchandise and supporting marketing material, comprising the steps of:

selecting a plurality of primary merchandising tasks;

paraphrasing each of the plurality of primary merchandising tasks for at least one of the plurality of merchandise into at least one sub merchandising task, forming a set of sub merchandising tasks;

combining the set of sub merchandising tasks into a standards manual; and

conducting a check-and-assessment of the plurality of merchandise using the set of sub merchandising tasks.

In a first variation to the invention, the plurality of primary merchandising tasks comprises Product Placement/Planogramming, Product Pricing, Product Availability/Service Levels, Product Promotion/P.O.P. Implementation, and Product Image/Freshness.

In a second variation, the invention further includes the step of using results from the check-and-assessment for evaluating performance of at least one person responsible for display of said merchandise.

The evaluating performance of the at least one person responsible for display of said merchandise may comprise the user performing sub merchandising tasks and determining the percentage of affirmative replies.

In a third variation, the invention further includes the step of using results from the check-and-assessment for generating a list of further things to do for merchandise management.

In a fourth variation, the invention further includes the step of using results from the check-and-assessment for generating a list of further things to do to complete merchandise management.

In a fifth variation, the invention further includes the step of using results from the check-and-assessment for printing P.O.P. or shelf price tags identified to be missing.

In a sixth variation, the invention further includes the step of using results from the check-and-assessment for generating a printed or electronic inventory order.

In a seventh variation, the invention further includes a set of sub merchandising tasks involving the use of at least one planogram.

In an eighth variation, the check-and-assessment of the plurality of merchandise comprises the steps of: performing at least one sub merchandising task of the set of sub merchandising tasks; and Recording the result of the at least one sub merchandising task.

In a ninth variation, the step of combining the set of sub merchandising tasks into a standards manual comprises storing the sub merchandising tasks in a storage of a computer, wherein the computer comprises a processor, memory, further storage, and communication facilities; and the step of conducting a check-and-assessment of the plurality of merchandise using the sub merchandising tasks comprises using a speaker element in electronic communication with the computer for providing a first voice information to the user from the computer and a microphone element in electronic communication with the computer for receiving a second voice information from the user and transmitting said second voice information in electronic form to the computer.

In accordance to a second aspect, this invention relates to a voice interactive system for assisting a user to manage merchandise for a plurality of merchandise and supporting marketing material, comprising:

A computer, comprising a processor, memory, storage, and communication facilities;

A speaker element in electronic communication with the computer for providing a first voice information to the user from the computer;

A microphone element in electronic communication with the computer for receiving a second voice information from the user and transmitting said second voice information in electronic form to the computer;

A file or database containing a plurality of sub merchandising tasks; and

Software stored at the computer for performing the steps assisting the user to conduct a check-and-assessment, the steps comprising:

Retrieving a sub merchandising task from the file or database;

Communicating the sub merchandising task to the user using the speaker element;

Receiving a response to the sub merchandising task from the user using the microphone element; and

Processing said response.

In a first variation to the system, the plurality of sub merchandising tasks are paraphrases of a plurality of primary merchandising tasks for the plurality of merchandise, including Product Placement/Planogramming, Product Pricing, Product Availability/Service Levels, Product Promotion/P.O.P. Implementation, and Product Image/Freshness.

In a second variation, the check-and-assessment is used for evaluating performance of at least one person responsible for display of said plurality of merchandise.

Evaluating performance of the at least one person responsible for display of said merchandise may comprise the user performing sub merchandising tasks and determining the percentage of affirmative replies.

In a second variation, the invention further comprises the step of using results from the check-and-assessment for generating a list of further things to do for merchandise management.

In a third variation, the invention further comprises the step of using results from the check-and-assessment for generating a list of further things to do to complete merchandise management.

In a fourth variation, the invention further comprises the step of using results from the check-and-assessment for printing P.O.P. or shelf price tags identified to be missing.

In a fifth variation, the invention further comprises the step of using results from the check-and-assessment for generating a printed or electronic inventory order.

In a sixth variation, the invention further comprises an electronic display for presenting the content of at least one planogram to the user.

In a seventh variation, the check-and-assessment of the plurality of merchandise comprises the steps of:

Performing at least one sub merchandising task of the set of sub merchandising tasks; and

Recording the result of the at least one sub merchandising task.

In an eighth variation, a headset comprises the speaker element and the headphone element for allowing the check-and-assessment to be conducted by the user hands-free.

In a ninth variation, the software comprises a speech recognition component for the step of receiving the response to the sub merchandising task from the user.

### BRIEF DESCRIPTION OF THE DRAWINGS

FIG. 1 illustrates performance summary.

FIG. 2 shows sections from a sample Standards Manual.

FIG. 3 shows sections from a sample Standards Manual.

FIG. 4 shows sections from a sample Standards Manual.

FIG. 5 shows sections from a sample Standards Manual.

FIG. 6 shows the opening screen.

FIG. 7 shows the main screen.

FIG. 8 shows the screen for the merchandise management menu.

FIG. 9 is a diagrammatic representation of the process flow.

FIG. 10 shows a flow chart for one implementation of the voice interactive system.

### DETAILED DESCRIPTION OF THE PREFERRED EMBODIMENTS

A preferred embodiment of the present invention uses a standards manual as a method of communicating expectations in performing standards and incorporating a method of checking, assessing and measuring performance of these standards.

Current use of Standards Manual by the majority of retailers has been ineffective because they do not clearly set out expectations. Nor are current use of Standards Manuals developed in a manner that would permits performance of the standards to be measured.

Paraphrasing

An important aspect of the Standards Manual of the present invention is that all of a retailer's standards as such relate to the execution of Primary Merchandising Tasks/PMT's (discussed below) are paraphrased as smaller, more specific Sub-Merchandising Tasks/SMT's. Compared to the prior art, the present invention's “paraphasing of SMT's” communicates performance expectations in a clearer, more concise manner. Additionally, converting retailing standard into smaller more specific tasks that can then be assessed as being performed “Yes” or not performed “NO”, enables the retailer to measure performance objectively. Existing Standards Manuals are designed for the most part as “resource tools” used to document and communicate factual information and not designed to clearly communicate expectation, making performance assessments so subjective to interpretation that they are not reliable, often causing more harm than good to workplace performance.

Another important aspect of the Standards Manual of the present invention is the identification of the five (5) Primary Merchandising Tasks (PMT) identified as the following:

1) Product Placement/Planograming

2) Product Pricing

3) Product Availability/Service Levels

4) Product Promotion/P.O.P. Implementation

5) Product Image/Freshness

These five (5) primary merchandising tasks (PMT) identify the merchandising tasks that cause the majority of a retailer's sales to be lost due to poor execution of standards. The present invention sets out to identify these five (5) primary merchandising tasks as a parameter for effective performance management in a retail environment. A retailer may still wish to add other smaller and less significant factors to this list. Primary merchandising tasks (PMT) are comprised of smaller more numerous and more specific sub merchandising tasks (SMT). For example the re-stocking of KitKat™ chocolate bars is a (SMT) of the (PMT) namely Product Availability/Service Levels. It is common for a store to carry as many as 10,000 different products, this store would be said to have 10,000 (SMT's) that make up it's Primary

Merchandising task (PMT) of Product Availability/Service Levels. This illustrates the challenge retailers face and the potential for loss sales due to poor performance of just this one single PMT.

It's important to note that paraphrasing relates to these sub merchandising tasks. And because of the large number of products carried, the Standards Manual paraphrases some SMT's in a PMT group, and still clearly communicates the standards and expectation

An example of a Product Placement/Planograming paraphrased is as follows: “Ensure that all products on the planogram are properly merchandised”. A copy of the planogram would be contained in the manual along with the paraphrase. If there are 100 different products on the planogram and a check-and-assess identifies that only 85 of the 100 items were properly planogrammed, an 85% measurement would be determined for Product Placement/Planograming. In this instance, all 100 Product Placement/Planograming SMT's are grouped together and linked to the planogram listing to be founding the Standards Manual.

A generic example of such an SMT would be: “Correctly merchandise [insert specific product, type of product or category of product] to planogram.” This question type is applicable for virtually all vendible products.

An example of a Product Pricing paraphrased is as follows: “Ensure that all products on the planogram are properly merchandised”. A copy of the retailer's price list would be contained in the manual along with this paraphrase. If there are 100 different products on the price list and a check-and-assess identifies that only 95 of the 100 items were properly priced, a 95% measurement would be determined for Product Pricing. In this instance, all 100 Product Pricing (SMT) are grouped together and linked to the planogram listing to be founding the Standards Manual.

A generic variation of this example question would be “Establish that price of [insert specific product, type of product or category of product] at or below maximum pricing [insert pricing scheme].”

An example of a Product Availability/Service Levels paraphrased is as follows: “Ensure that stock levels on all products found on the planogram are properly merchandised”. A copy of the planogram or a listing of the products on the planogram would be contained in the manual along with this paraphrase. If there are 100 different products on the planogram or list and a check-and-assess identifies that only 60 of the 100 items were on the shelves, a 60% measurement would be determined for Product Availability/Service Levels. In this instance, all 100 Product

Availability/Service Levels (SMT) are grouped together and linked to the planogram listing to be founding the Standards Manual.

A generic variation of this “Maintain an in-stock position of all [insert specific product, type of product or category of product] on the planogram.”

An example of a Product Promotion/P.O.P. implementation paraphrased is as follows: “Ensure that all products on the promotional signage are properly displayed”. If there are 100 different promotional signs to be properly displayed and a check-and-assess identifies that only 95 of the 100 items were properly displayed, a 95% measurement would be determined for Product Promotion/Planograming. In this instance, all 100 Product Promotion/P.O.P. SMT are grouped together.

A generic example of this is: “Ensure properly display of [insert specific signage to be found, i.e. shelf talkers, counter promotional sign].”

An example of a Product/Store Image paraphrased is as follows: “Ensure that none of the products on the shelf are ‘expired’ or damaged”. If there are 100 different products where a check-and-assess identified that 5 of the 100 items were expired or damaged, a 95% measurement would be determined for Product Image/Freshness. In this instance, all 100 Product/Store Image SMT's are grouped together.

“Maintain the image of [insert specific product, type of product or category of product] freshness by checking expiration dates and removing outdated products from shelf” and “Keep [insert specific product, type of product or category of product] clean and remove any soiled or opened product from the shelf” are further examples of paraphrasing SMT's for Product/Store Image.

An aspect of the Standards Manual of the present invention is Performance Summary used to quantify as a percentage. 100% representing perfect performance. An important aspect of the Summary reporting of performance measurement is that it is done in a way that mirrors the standards manual of the present invention. This facilitates easily understood dialog that would follow between management and store personnel.

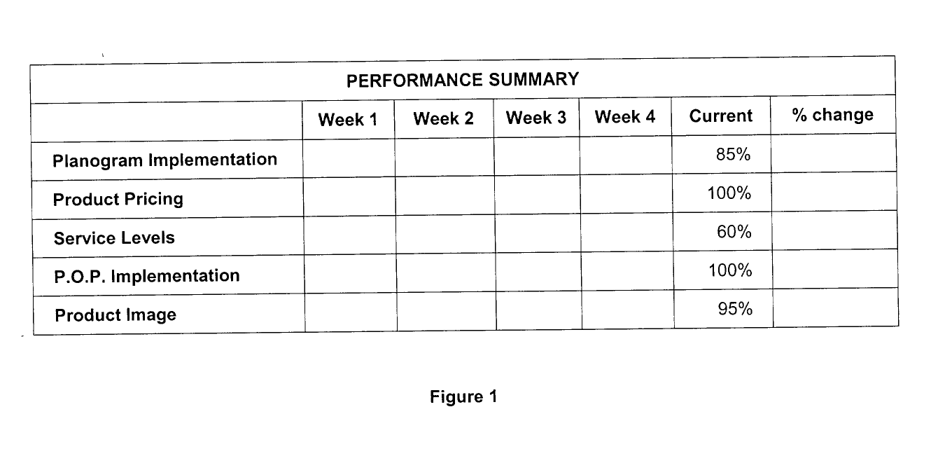

FIG. 1 is a sample Performance Summary indicating the store's overall performance in the five (5) Primary merchandising tasks (PMT's). The merchandise or store manager might delegate each Primary merchandising task (PMT) to a different person or team of people for the 5 tasks and will be able to use this summary to communicate performance results to the individual stakeholders.

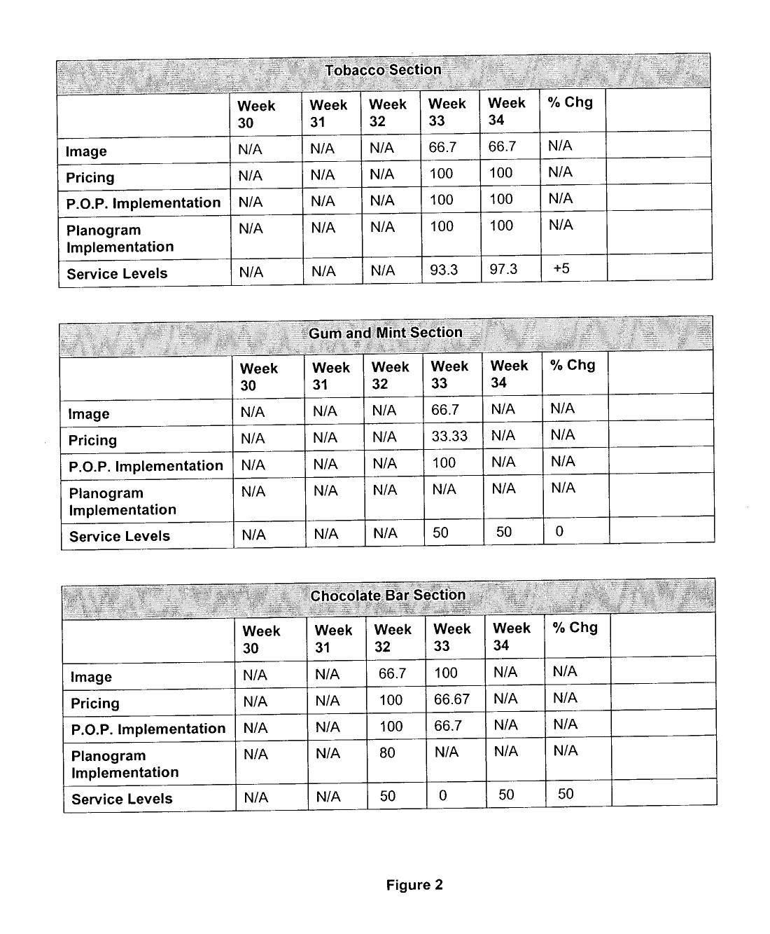

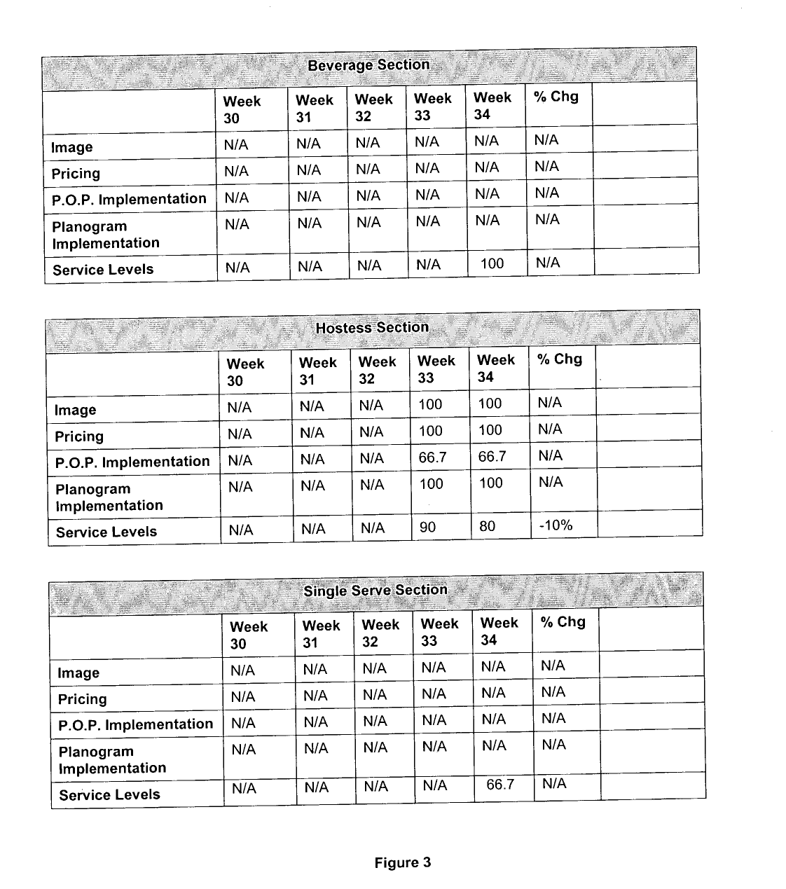

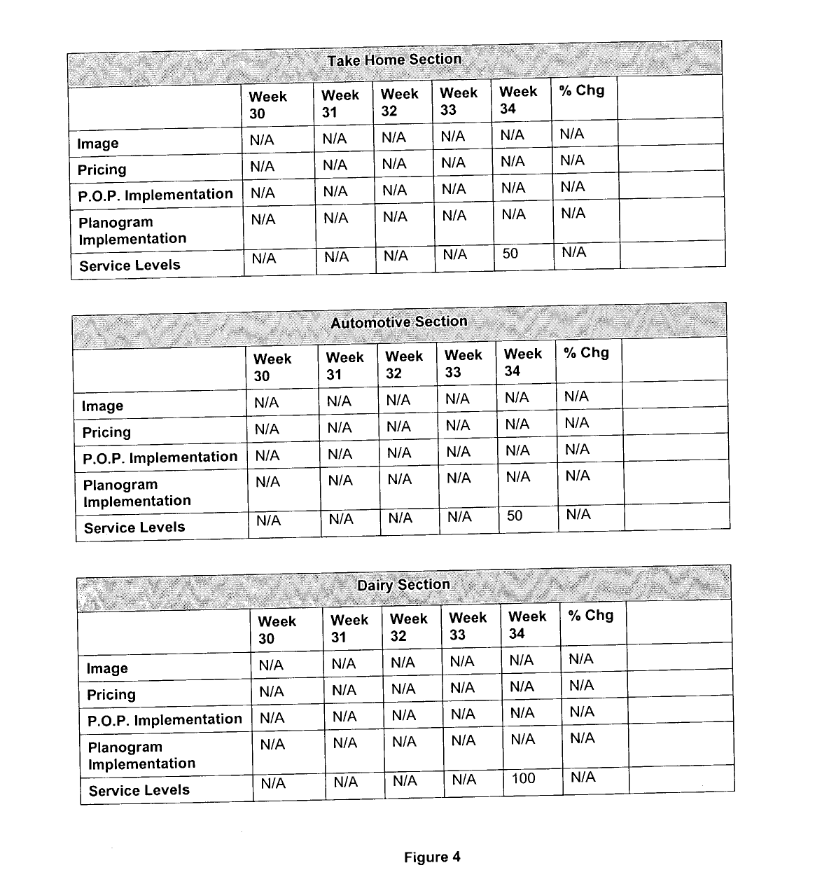

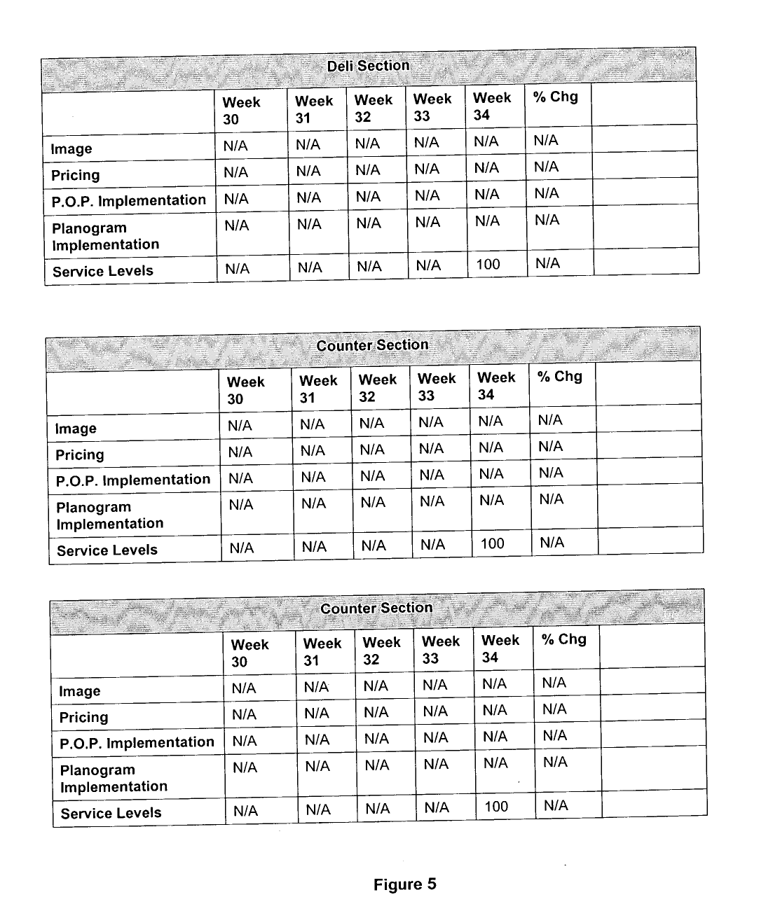

The elements in FIGS. 2 to 5 jointly constitute an example of a Performance Summary indicating the performance broken down by section department or product category and then into the five (5) Primary merchandising tasks (PMT's). The merchandise or store manager might delegate the entire section, department or product category to an employee Team of employee's and will be able to use this summary to communicate performance results to the individual stakeholders.

Strategically, the Performance Summary identifies where the opportunities for improvement exists. In the case of the FIG. 1 for overall store Performance Summary, Service Levels is shown as a clear area where more resources should be placed with potential opportunity for improving performance. Product Pricing and P.O.P. Implementation on the other hand indicate proper performance level and may possible be where less resources may be required without effecting performance levels.

In either of these two reporting examples (FIGS. 1, and FIGS. 2 to 5), week-by-week results can be tracked to show progression or digression in performance, further aiding the dialog between management and store personnel.

By way of an operative example, the principles identified above have been incorporated into a Standards Manual entitled Best Practice Retailing Standards in Schedule 1. By following the method embodied in the manual and working through a check and assessment of in-store corresponding sections, a manager or designated employee can identify and determine whether any tasks have been completed in order to conform the retailing area to the established retailing standards. A list of items to be done, in order to bring the retail area into compliance with the standards set out in the manual, can be determined with reference to the particular items where performance was determined to be less that 100% (or an acceptable level), based on the completion of the page by page analysis of the manual while reviewing the retail area to which the manual relates.

The employee or Team of employees responsible for the retail area will obtain a quantified, objective indicator of their level of performance and compliance relative to a perfect level established by the retailing standards manual. This information on performance and compliance can be tracked over time to determine which areas and/or employees consistently under-perform and require targeted efforts to improve performance/compliance with standards. The performance of employees charged with responsibilities for the tasks in a given retail area can be judged against the standards provided in the manual.

Another embodiment relates to a system using bi-directional voice communication which allows the merchandising system to be automated and operated by voice (abbreviated in this document as “Voice Computing” or the “System”). Each Sub merchandising task is posed as a question that is transmitted from a base computer to a remote unit including a headphone/microphone worn by the assessor. For example, the base computer transmits the following question: “Is the Kit Kat promotional sign properly displayed ?”. The assessor responds to the questions with voice inputs relative to the observed performance of the standard: a “Yes” voice input if the task was properly completed; a “No” voice input if the task was not properly completed. The inputted voice response from the assessor is then transmitted back to the base computer, which records, correlates and tabulates the responses into a performance summary.

Voice Computing

The System (Voice Computing) is a system with hardware and software components for automating the check-and-assessment process associated with a Standards Manual performed by a user. The means of carrying out the process, typically a writing instrument such as a pen and a printed copy of the manual, is replaced by electronic devices as part of a multimedia system. A computer (the “Computer”), having electronic memory elements for storing the contents of the Standards Manual (a file or database including an electronic version of the associated voice track), runs software to facilitate the check-and-assessment process. The Computer may be part of a telecommunication network of such computers and other network devices, such as a local area network (LAN), an intranet, extranet, or the Internet.

The remote unit of the system corresponding to the assessor/user has a number of input-output elements. These include a visual display such as a LCD or CRT display and a voice input-output device, such as a headphone/microphone headset (more generically microphone and speaker). An electronic device for entering characters is also included, such as a manual pointing device such as a mouse or trackball (specially coupled with the display as in the case of PDA's), or a keyboard. These are linked electronically either directly with the display, or via the Computer. A printed copy of the Standards Manual may be included as the means by which information such as the planogram (instead of a CRT or LCD display screen) is displayed. There may be one component of the remote unit to act as an intermediary between the Computer and the i/o devices in collecting and distributing signals in both directions. In a further variation, there may be further intermediary devices, such as routers and switches between the Computer and the remote unit (networking on a peer-to-peer or client-server basis).

Alternatively, the i/o devices are connected to the Computer with the related signals (in communication channels) associated with the particular user. The link between the Computer and the remote unit may be by cable or wireless telecommunication means.

In order to facilitate the check-and-assessment process, a voice recognition component is part of the software run by the Computer. One advantage of using Voice Computing is its “hands-free” characteristic which allows the assessor to make small correcting adjustment with his/her hands, thus further aiding the merchandising of products in the stores and increasing merchandising efficiency.

Each task is posed as a question that is transmitted from the Computer to the remote unit (the headphone/microphone worn by the assessor). For example, the Computer transmits the following question either visually as displayed on the screen or verbally by the headphone: “Is the KitKat™ promotional sign properly displayed ?”. A graphic of a correct display may also be displayed on screen or its location (page number) recited in an accompanying Standards Manual. The assessor then responds orally to the questions relative to the observed performance of the standard: a “Yes” voice input if the task was properly completed; a “No” voice input if the task was not properly completed. The inputted voice response from the assessor is then transmitted back to the base computer, which captures, recognizes, records, correlates and tabulates the responses (ultimately into a performance summary). There are a large number of technologies available for speech recognition and synthesis. The responses are preferably, but not exclusively, of the Yes-No binary type. For example, a number may also be the response in relative to a question about the inventory quantity of a certain product placed on a shelf. Pre-determined minimum inventory levels enables the computer to sort “Yes” inputs from response indicating inventory levels at or above the minimum. Conversly, “No” inputs would come from responses indicating inventory levels below the minimum. The purpose of using the inventory quantity rather then a simple “Yes/No” is to allow the system to operate as a perpetual inventory order device. To be discussed in more detail later in embodiment that explains how the system can further aid the merchandising.

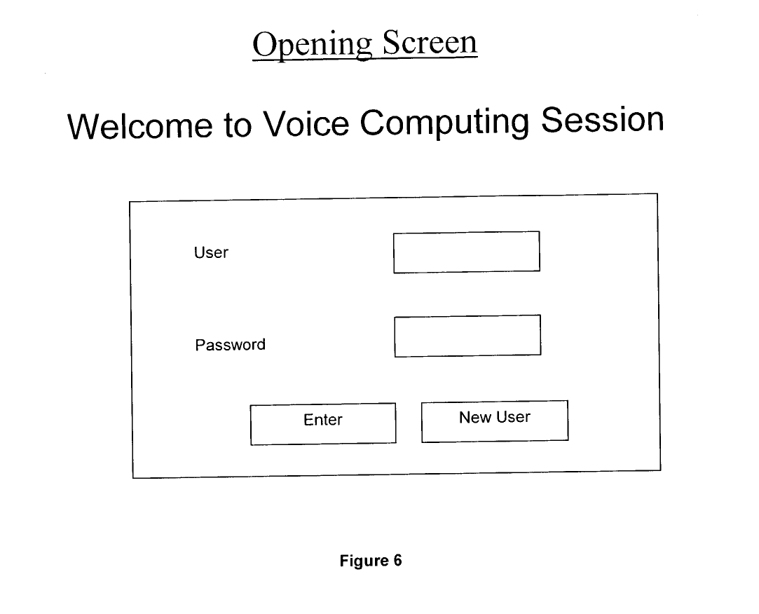

FIGS. 6 to 8 illustrate one possible initial series of screen displayed to a user of the System. As shown in FIG. 6, the user is first required to enter his user identifier and password in the corresponding text boxes. Once selecting and clicking on the box indicated as “Enter”, the user is permitted to initiate a new session.

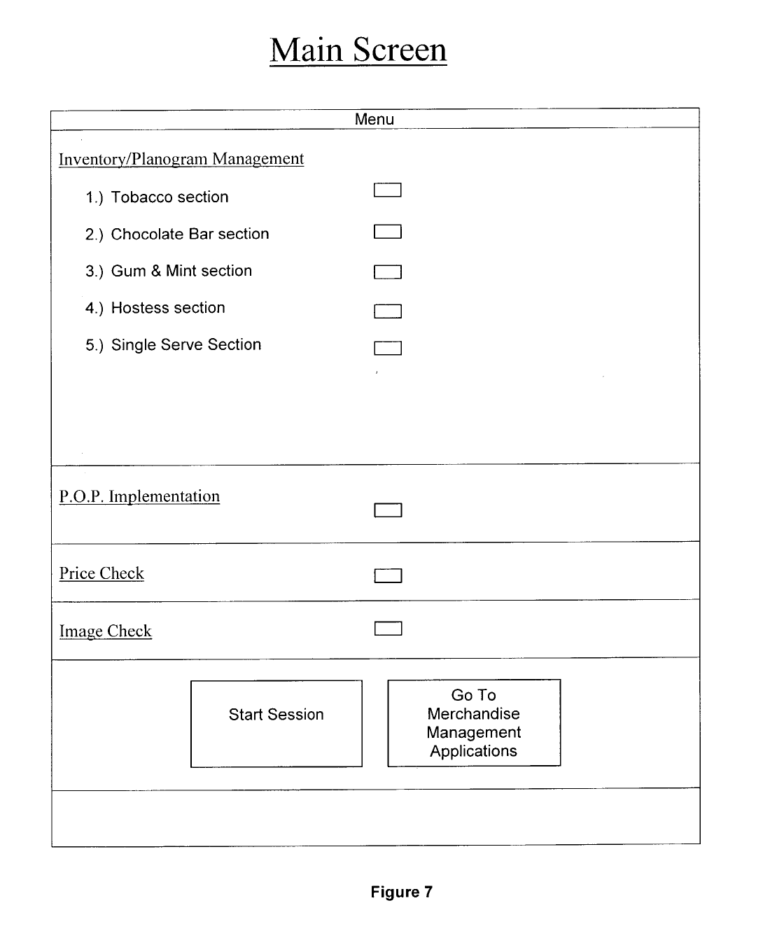

Each session commences with a selection of the task areas to be performed as part of the check-and-assessment. FIG. 7 illustrates one possible layout for this menu screen, permitting the user to select the specific task areas and the order in which the areas are to be performed. The actual check-and-assessment process involving questions is then carried out. The user has at all times the option of returning to this menu.

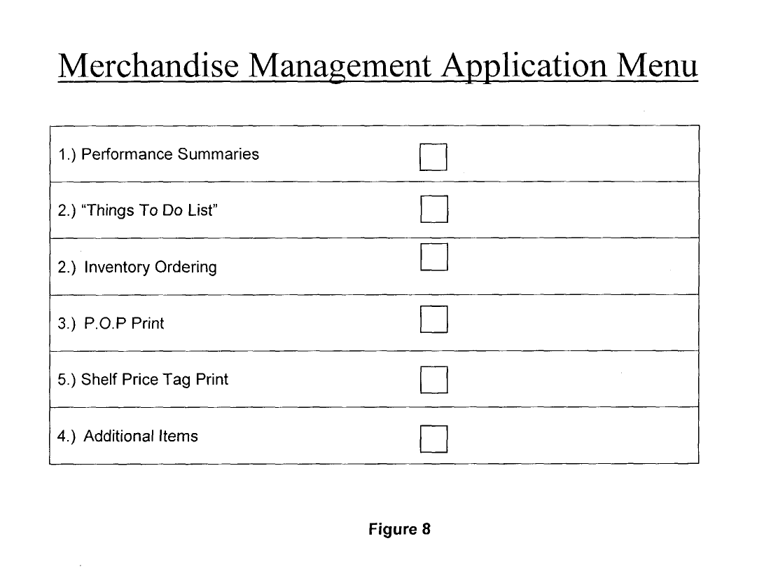

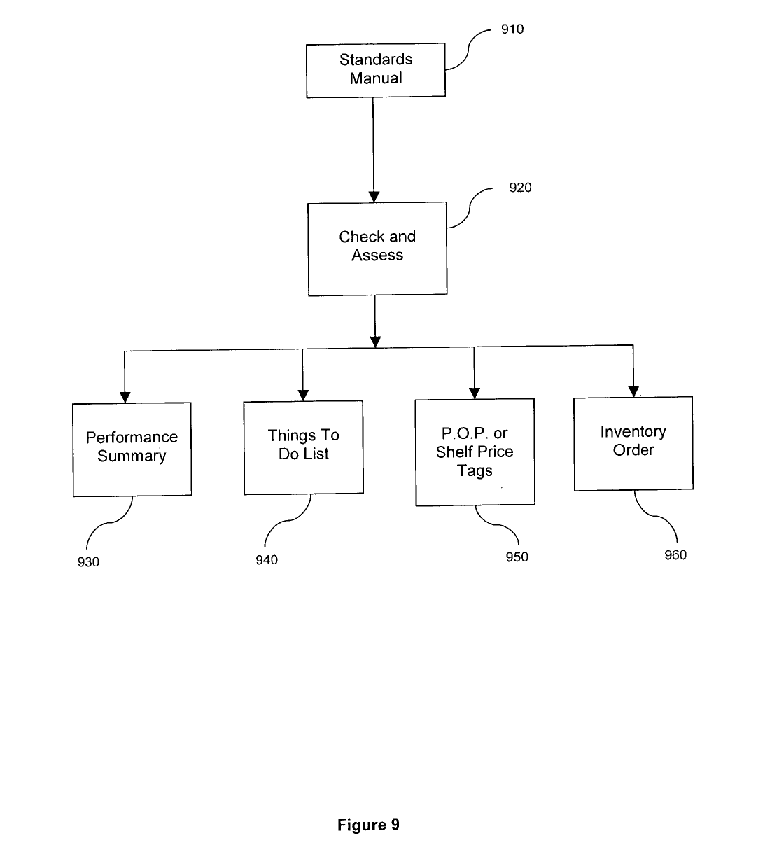

Once the check-and-assessment has been completed (or a part thereof), the user (with properly authorization) can generate a report (including hardcopies) by indicating to the System to initiate and show the Merchandising Management Application screen (sample shown in FIG. 8). At this point, a number of reports can be generated. The reports in FIG. 8 are discussed in further detail below in relation to FIG. 9.

This invention optionally includes software modules for entering questions into a particular System for a particular check-and-assessment session. For example, a software component may allow a manager or merchandising specialist to produce an electronic Standards Manual (including possible interface software with other merchandising systems, such as an inventory database or standalone system), including questions under each of the categories for each product and any graphic display. In addition to a session linked to the planograms, sessions can be linked to coincide with a list of pre-set initiative, a list of a specific group of products to be checked (i.e. only those products on promotion to be checked) as well, the Standards Manual can then be used as the basis for the check-and-assess session.

The system may also run a component using the Standards Manual as a basis as a training session tool, which requires the trainee to respond with affirmation that they understand what they read in the standards manual and what they observe. The benefit of linking the training with the check and assess is that there is even greater consistency in expectations. This would have tutorial capabilities that would allow the trainee to call up “Help” for more clarification of the standard and expectation.

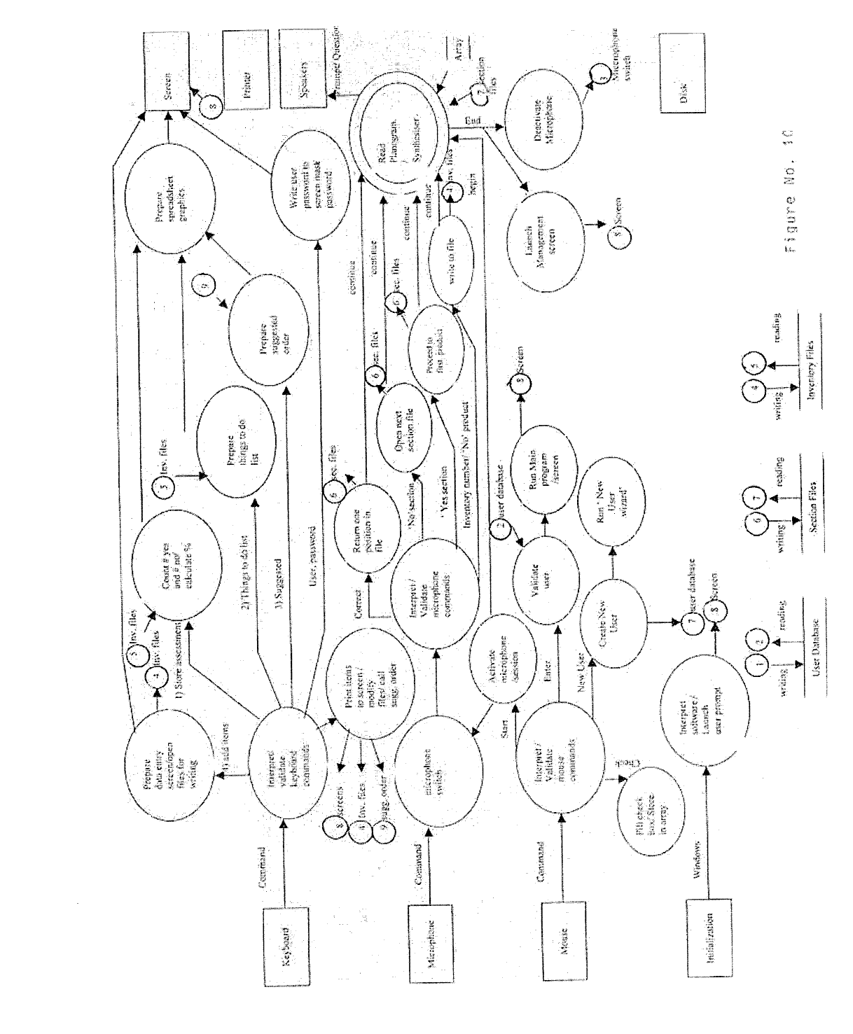

FIG. 10 shows the process flow of a preferred embodiment. Square boxes indicate input and output means; oval boxes show functions; parallel horizontal entities denote one or more files or databases (storage of information); and circular entities with inset numerical reference and accompanying arrow refer to or indicate the presence of a separate section of the overall flow chart.

Sequencing and Combining Questions

One important advantage of using Voice Computing is that sequentially asked questions of a normal nature can be posed in combinations for reducing redundancies and taking advantage of heuristics, making this significantly more time effective than other methods. Two steps are involved here. Firstly, the normal set of questions for a Standards Manual is produced; then analysis follows of the questions for sequencing and combining purposes and generating the hierarchical order in which the reduced set questions should be posed (as for example in a decision tree or flow chart) is carried out. These steps are typically performed by the manager or a merchandising specialist and then entered into the System for a particular session of check-and-assessment.

An example sequencing and combining questions is as follows: The base computer poses a question about the inventory level of a product in the order that product is planogrammed to appear on the shelves, if read from left to right. If the assessor answers with a “NO” voice input response, the base computer records the “No” voice input responses as an indicator that the product in question was not the product in that place on the planogram. If the assessor answers with a inventory quantity example “24“voice input response, the base computer records a response for 2 sequentially combined questions. The base computer records a yes to the product being in the sequentially correct place on the planogram. At the same time, the base computer records either a “Yes or No” for Product availability, depending on the pre-determined minimum/critical inventory level set for that product

In addition to sequencing questions, the answer to a single combination question can form indicators of the validity of a number of related propositions . For example, the base computer might ask the assessor “What is the inventory of KitKat™ chocolate bars and are they promotionally priced at 99 cents ?” If the assessor responds with a number, e.g. 24, the base computer records not only that a quantity of 24 is the inventory amount indicating that KitKat™ is available, but also that it indicates the following: The system user would be instructed or trained (possibly under a training component of the System) to answer in a hierarchy simply as follows: If all responses are positive the response is a quantity response. The computer will accept “yes” for the other 4 propositions. If all responses are “”No” the order of utterances are (1) “wrong” for wrong price; (2) “no” for product is not found in that place on shelf; (3)” damaged” for damaged product; (4) “missing” for missing P.O.P. (material etc.); and (5) a “quantity” for inventory/service level, referring to the actual numerical quantity. As far as the invention is concerned, “wrong” is actually a “no”-type answer. Likewise, If an assessor checks the quantity and it is below the minimum/critical level established, then the answer is “no” to the implied question/instruction “Maintain an in-stock position on that product”. Based on the assessor's “quantity” response of 24 to the above mentioned question, the base computer would record that:

KitKat™ is properly planogrammed;

KitKat™ is properly priced at 99 cents;

the KitKat™ product has not past its expiry date nor has it been damaged; and

the KitKat™ product has a promotional sign properly displayed. Properly display only relates to P.O.P.

If the assessor response with a “No” to the above question, the base computer records the “No” input response that KitKat™ is not properly planogrammed. The base responds then follows with the follow-up question, “Is Kit Kat™ somewhere else on the shelf, if so what is the inventory of KitKat™ ?” If the assessor responds with a number, e.g. 12, the base response records not only 12 as the inventory figure indicating that KitKat™ is available, it also indicates to the base computer:

KitKat™ is properly priced at 99 cents;

KitKat™ product was not expired or damaged; and

the KitKat™ product has a promotional sign properly displayed.

If the assessor responds with “Wrong” to the original question. “What is the inventory of KitKat™ chocolate bars and are they promotionally priced at 99 cents ?”, the base computer records the “Wrong” input response that KitKat™ is not properly priced at 99 cent. The base computer asks the follow-up question “what is the inventory of KitKat™ ?” If the assessor responds with a number, e.g. 12, the base computer records 12 as the inventory figure indicating that KitKat™ is available, and the response indicates to the base computer that the KitKat™ product was not expired or damaged. The assessor will only respond with the number of vendible products, being trained to only include saleable items in inventory amount. Therefore if there is a quantity of 24 and one is damaged the response to the question would be “23”. It also indicates to the base computer a “yes” response that the KitKat™ product has a promotional sign properly displayed. It would only count as a “Yes or no” response if a tag line on the original questions voice prompt. If no tag line is uttered by the computer, the computer and the assessor ignores that step and there is no effect on the % for P.O.P.

If the assessor responds “Damaged”, the base computer records the “Damaged” input response that KitKat™ is expired or damaged. If one or more are damaged the response is “Damaged” because it effects the freshness image of that product and others. The user will be trained on what is damaged, i.e. torn or faded labels, have empty or opened packages and soiled basically. The base computer asks the follow-up question “what is the inventory of KitKat™ ?” (referring to the undamaged portion of goods). If the assessor responds with a number, e.g. 12, the base response records not only 12 as the inventory figure indicating that KitKat™ is available, it also indicates a “yes”-input response that KitKat™ is properly priced at 99 cents It indicates to the base computer a “yes”-input response that the KitKat™ product has a promotional sign properly displayed.

If the assessor response with “Missing”, the base computer records the “Missing” input response that the KitKat™ promotional sign is not properly displayed. The base computer asks the follow-up question “What is the inventory of KitKat™ ?” If the assessor responds with a number, e.g. 12, the base computer records not only 12 as the inventory figure indicating that KitKat™ is available, it also indicates to the base computer a “Yes” input response that KitKat™ is properly priced at 99 cents. It indicates to the base computer a “yes” input response that the KitKat™ product was not expired or damage.

When a product is on promotion, the starting question for that product will be something like “What is the inventory of KitKat™, is there a shelf talker (P.O.P.) and is the product priced at 99cents ?” The expected responses are varied accordingly.

This aspect of the present invention enables the assessor to check-and-assess the five (5) Primary merchandising tasks (PMT's) all at once, in a very time effective manner. This aspect is not limited to these five (factors), an unlimited number of factors can be checked with appropriate modifications which would be clear to the person skilled in the art.

A preferred embodiment of the present invention uses the System including the core check-and-assess methodology to perform computerized functions that further aid the execution of merchandising tasks in addition to producing a Performance Summary.

The base computer uses the negative input responses captured during the performance check-and-assess session i.e. all of the “Missing”, “Damaged”, “Wrong”, “No” and “Quantity” that are below minimums/critical levels as deficiencies. These no-type or deficient responses collectively summarize the store's opportunities for improvement and requirements for timely corrective action.

A chart of the possible process flow is indicated in FIG. 9. At step 910, a Standards Manual is created and obtained by a store manager, which sets the standards/expectations and paraphrase in question with preferably Yes/No type answers. Also may be set at step 910 are parameters for a Performance Audit which may be invoked later (as step 930).

The next step is the check-and-assess session during step 920 using Voice Computing or done manually.

As referred to earlier in relation to FIG. 8, the System, incorporating the check-and-assess method, can be used as an aid in merchandising management to produces various reports. This would include a printed version of a “Things to do list” to be utilized as a delegation tool (step 940). All negative responses can be summarized in a “Things to do list” and printed in a “Things to Do” report format after a check-and-assess session has been completed (during step 920). Every product on the planogram can be coded in the programming of the computer with a specific employee or department identified. This allows for printing of separate “Things to Do” reports for each of the individual stakeholders. This results in greater time and cost effectiveness.

Another way this system can be used as an aid in merchandising management is to reproduce printed P.O.P. or shelf price tags at the base computer printer (step 950). Responses that have identified missing P.O.P. or the wrong price during the check-and-assess session (step 920) can be summarized and printed after a check-and-assess session has been completed. The printed P.O.P. and/or shelf price tags can be immediately delegated to the appropriate employee so that corrective action may then take place. Every product on the planogram can be coded with a specific employee or department identified so that separate batches of P.O.P. or shelf price tags can be run for each individual stakeholders.

A further way the System can be used in merchandising management is to produce (at step 960) a printed or electronic inventory order that can be sent to the supplier immediately following a check-and-assess session (step 920). All inventory response may be captured on a “Stock card styled” spreadsheet capable of keeping a perpetual inventory and generate a product order. Items with inventory levels inputted below minimum/critical levels trigger an output response printed to the appropriate suppliers pre-formatted order form. Every product on the planogram is coded in the programming of the computer with a suppliers code to identify the source for replenishment.

In a variation, such orders are sent electronically to a supplier using a Business to Business system, such as that implemented using the Internet or any other means of telecommunication.

The retailer may choose to run a check-and-assess session for any one of the purpose above or other customized reports.

The use of the voice-based system, including the check-and-assess method of inventory levels of products and producing a printed or electronic inventory order, is a method embodied in the present invention (as indicated above for step 960 of FIG. 9). Voice Computing in this manner can also be used by suppliers acting on their own behalf during a sales call to the retailer's store or by any organizations in any other industries that require replenishment of inventories or supplies. The system is viable and universal in most industries where workplace performance, price audit, supplies and inventories etc. are a factor. Voice Computing, combined with a check-and-assess of inventory for the purpose of reordering can take the form of any inventory or supply listing, in the same way as a planogram listing. The method creates much greater time and cost effectiveness then any prior arts methods found in retailing today.

It will be appreciated that the above description relates to the preferred embodiments by way of example only. Many variations on the apparatus for delivering the invention will be clear to those knowledgeable in the field, and such variations are within the scope of the invention as described and claimed, whether or not expressly described.

All patents, patent applications, and publications referred to in this paper are incorporated by reference in their entirety.

SCHEDULE 1

| Standard | On Standard | Off Standard | Assessment Value |
|---|---|---|---|
| Best Practice Retailing Standards | | | Tobacco Category |
| Image | | | |
| 1.) Keep Tobacco Supertrays full. | 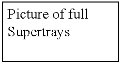 | 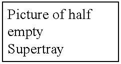 | One (1) point value is given for keeping Supertrays full. |
| 2.) Brands packaging displayed so that pack front faces customer. | 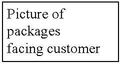 | 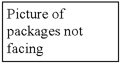 | One (1) point value is given for merchandising all tobacco product facing the customer |
| 3.) Use coloured brand strips supplied by the cigarette company's. | 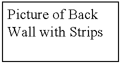 | 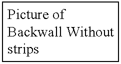 | One (1) point value is given for using manufactures coloured strips on all tobacco shelves |
| Image Scoring | | | 3 out of 3 = 100% |
| | | | 2 out of 3 = 66.6% |
| | | | 1 out of 3 = 33.3% |
| Tobacco Pricing | | | |
| 1.) 20 packs at or below maximum pricing established by price survey. | 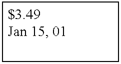 | 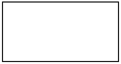 | One (1) point value is given for pricing 20 packs at or below maximum pricing. |
| 2.) 25 packs at or below maximum pricing established by price survey. | 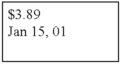 | 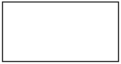 | One (1) point value is given for pricing 25 packs at or below maximum pricing. |
| 3.) Carton packs at or below maximum pricing established by price survey. | 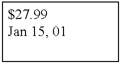 | 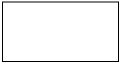 | One (1) point value is given for pricing Carton packs at or below maximum pricing. |
| Price Strategy Scoring | | | 3 out of 3 = 100% |
| | | | 2 out of 3 = 66.6% |
| | | | 1 out of 3 = 33.3% |
| P.O.P. Implementation | | | |
| 1.) Properly display CTP authorized interior price identification sign on backwall. | 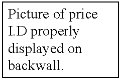 | 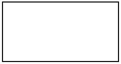 | One (1) point value is given for displaying CTP authorized interior cigarette price signs. |
| 2.) Properly display CTP authorized exterior price identification sign on outside pole. | 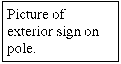 | 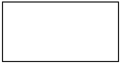 | One (1) point value is given for displaying CTP authorized exterior cigarette price signs. |
| 3.) Properly display approved age restriction signs on beside backwall. | 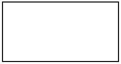 | 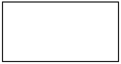 | One (1) point value is given for using approved age restriction sign beside backwall. |
| P.O.P. Implementation | | | 3 out of 3 = 100% |
| Scoring | | | 2 out of 3 = 66.6% |
| | | | 1 out of 3 = 33.3% |
| Planogram | | | |
| Implementation | | | |
| 1.) Correctly merchandise tobacco shelves to planogram. | 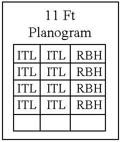 | 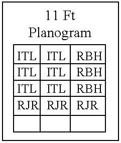 | One (1) point value for every shelf properly set to planogram. Total of twelve (12) points are assessed for tobacco planogram. |
| 2.) Properly display the ITL and RBH counter display in a visible area of the pay point counter. | 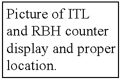 | 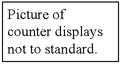 | One (1) point value for every tobacco counter display properly in position. Total of two (2) points are assessed for tobacco counter displays. |
| Planogram Scoring | | | 14 out of 14 = 100% |
| Service Level | | | |
| 1.) Carry the Top 75 SKU's of tobacco products. And maintain the Top 30 SKU's at all time. | 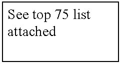 | 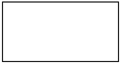 | One (1) point value for each Top 30 SKU's in-stock. Fewer then 4 packs of any Top 30 SKU is considered out or about to be out of stock. |
| Service Level Scoring | | | 30 out of 30 = 100% |
| Best Practice Retailing Standards | | | Gum & Mint Category |
| Image | | | |
| 1.) Maintain freshness of product by checking expiration dates on products regularly. Remove outdated product from the shelf. | 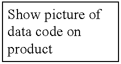 | 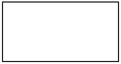 | One (1) point value for each of the 73 SKU's so long as the packages for each SKU are not expired, soiled, or opened |
| 2.) Maintain the Gum & Mint display by always keeping the product packaging clean and unopened | 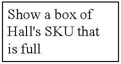 | 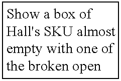 | |
| Image Scoring | | | 73 out of 73 = 100% |
| Pricing Strategy | | | |
| 1.) Price regular gum at or below maximum pricing established by price survey. | 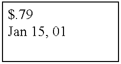 | 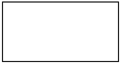 | One (1) point value is given for pricing Regular gum at or below maximum pricing. |
| 2.) Price premium gum at or below maximum pricing established by price survey. | 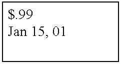 | 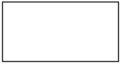 | One (1) point value is given for pricing Premium gum at or below maximum pricing. |
| 3.) Price SuperPak gum at or below maximum pricing established by price survey. | 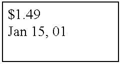 | 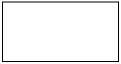 | One (1) point value is given for pricing Superpak gum at or below maximum pricing. |
| Pricing Strategy Scoring | | | 3 out of 3 = 100% |
| | | | 2 out of 3 = 66.6% |
| | | | 1 out of 3 = 33.3% |
| P.O.P. Implementation | | | |
| 1.) Properly Display price identification signs. | 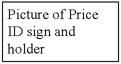 | 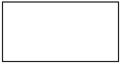 | One (1) point value is given for properly using the Gum & Mint Price Id. sign and holder. |
| 2.) Properly display current monthly promotional shelf danglers. | 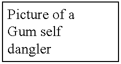 | 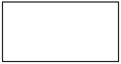 | One (1) point value is given for properly using the current Gum & Mint promotional shelf dangler. |
| 3.) Properly display current monthly promotional counter signs. | 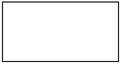 | 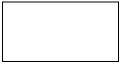 | One (1) point value is given for properly using the current Gum & Mint promotional counter sign. |
| 4.) Properly display current monthly promotional Nozzle Talkers. | 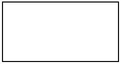 | 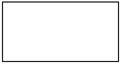 | One (1) point value is given for properly using the current Gum & Mint promotional Nozzle Talkers. |
| 5.) Properly display current monthly promotional Pump Toppers. | 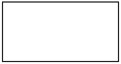 | 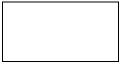 | One (1) point value is given for properly using the current Gum & Mint promotional Pump Topper. |
| P.O.P. Implementation | | | 5 out of 5 = 100% |
| Scoring | | | 3 out of 5 = 60% |
| | | | 1 out of 5 = 20% |
| Planogram | | | |
| Implementation | | | |
| 1.) Correctly merchandise Gum & Mint section as per planogram. | 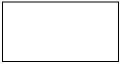 | 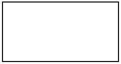 | One (1) point value for each of the 75 items on planogram so long as each is merchandised in the proper location. |
| Planogram | | | 75 out of 75 = 100% |
| Implementation | | | |
| Scoring | | | |
| Service Level | | | |
| 2.) Maintain an in- stock position of all Gum & Mint SKU's on planogram. | 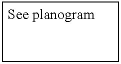 | 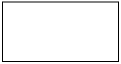 | One (1) point value for each of the 73 SKU's in-stock. Fewer then 6 packs of any SKU is considered out or about to be out of stock. |
| Service Level Scoring | | | 73 out of 73 = 100% |
| Best Practice Retailing Standards | | | Chocolate Bar Category |
| Image | | | |
| 3.) Maintain freshness of product by checking expiration dates on products regularly. Remove outdated product from the shelf. | 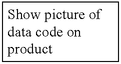 | 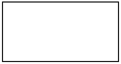 | One (1) point value for each of the 44 SKU's so long as the packages for each SKU are not expired, soiled, or opened |
| 4.) Maintain the Chocolate Bar display by always keeping the product packaging clean and unopened | 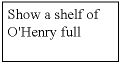 | 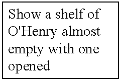 | |
| Image Scoring | | | 44 out of 44 = 100% |
| Pricing Strategy | | | |
| 4.) Price regular bars at or below maximum pricing established by price survey. | 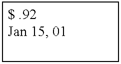 | 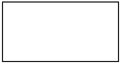 | One (1) point value is given for pricing Regular Bars at or below maximum pricing. |
| 5.) Price King Size Bars at or below maximum pricing established by price survey. | 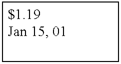 | 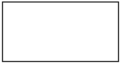 | One (1) point value is given for pricing King Size Bars at or below maximum pricing. |
| Pricing Strategy Scoring | | | 2 out of 2 = 100% |
| | | | 1 out of 2 = 50% |
| P.O.P. Implementation | | | |
| 6.) Properly display price identification sign for Chocolate Bars. | 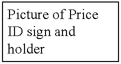 | 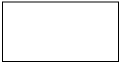 | One (1) point value is given for properly using the Chocolate Bar Price Id. sign and holder. |
| 7.) Properly display current monthly promotional shelf dangler for chocolate bars. | 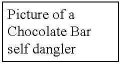 | 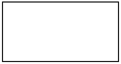 | One (1) point value is given for properly using the current Chocolate Bar promotional shelf dangler. |
| 8.) Properly display current monthly promotional counter sign. | 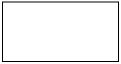 | 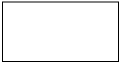 | One (1) point value is given for properly using the current Chocolate bar promotional counter sign. |
| 9.) Properly display current monthly promotional Nozzle Talkers for chocolate bars. | 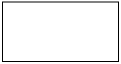 | 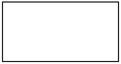 | One (1) point value is given for properly using the current Chocolate Bar promotional Nozzle Talkers. |
| 10.) Properly display current monthly promotional Pump Toppers for chocolate bar. | 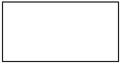 | 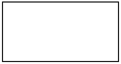 | One (1) point value is given for properly using the current Chocolate Bar promotional Pump Topper. |
| P.O.P. Implementation | | | 5 out of 5 = 100% |
| Scoring | | | 3 out of 5 = 60% |
| | | | 1 out of 5 = 20% |
| Planogram | | | |
| Implementation | | | |
| 2.) Merchandise Chocolate Bar section as per planogram. | 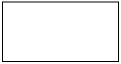 | 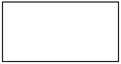 | One (1) point value for each of the 57 items on planogram so long as each is merchandised in the proper location. |
| Planogram | | | 57 out of 57 = 100% |
| Implementation | | | |
| Scoring | | | |
| Service Level | | | |
| 2.) Maintain an in- stock position of all Chocolate Bar SKU's on planogram. | 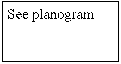 | 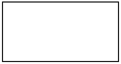 | One (1) point value for each of the 44 SKU's in-stock. Fewer then 6 packs of any SKU is considered out or about to be out of stock. |
| Service Level Scoring | | | 44 out of 44 = 100% |
| Best Practice Retailing Standards | | | Beverage Category |
| Image | | | |
| 1.) Maintain freshness of product by checking expiration dates on products regularly. Remove outdated product from the shelf. | 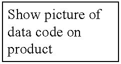 | 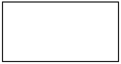 | One (1) point value for each of the 173 SKU's so long as the bottles for each SKU is faced up, not expired, or soiled. |
| 2.) Maintain the Beverage display by always keeping the product packaging clean and faced up. | 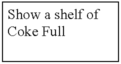 | 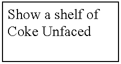 | |
| Image Scoring | | | 178 out of 178 = 100% |
| Pricing Strategy | | | |
| 1.) 355 ml Cans at or below maximum pricing. | 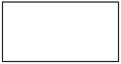 | 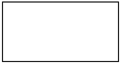 | One (1) point value is given for pricing 355 ml cans at or below maximum pricing. |
| 2.) 600 ml bottles at or below maximum pricing | 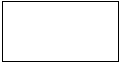 | 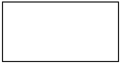 | One (1) point value is given for pricing 600 ml bottles at or below maximum pricing. |
| 3.) 1 lt bottles at or below maximum pricing | 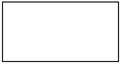 | 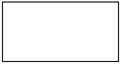 | One (1) point value is given for pricing 1 lt bottles at or below maximum pricing. |
| 4.) 2 lt bottles at or below maximum pricing | 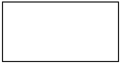 | 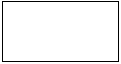 | One (1) point value is given for pricing 2 lt bottles at or below maximum pricing. |
| 5.) 473 ml Alternative Bev. at or below maximum pricing | 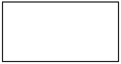 | 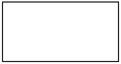 | One (1) point value is given for pricing 473 ml Alt. Bev. at or below maximum pricing. |
| 6.) 571 ml Neutracitical drinks at or below maximum pricing | 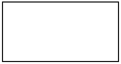 | 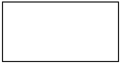 | One (1) point value is given for pricing 571 ml Neutracitical at or below maximum pricing. |
| 7.) 710 ml Gatorade at or below maximum pricing | 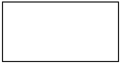 | 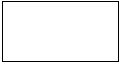 | One (1) point value is given for pricing 710 ml Gatorade at or below maximum pricing. |
| 8.) 500 ml Montclair water at or below maximum pricing | 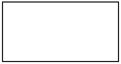 | 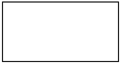 | One (1) point value is given for pricing 500 ml Montclair at or below maximum pricing. |
| 9.) 710 ml Montclair water at or below maximum pricing | 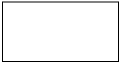 | 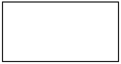 | One (1) point value is given for pricing 710 ml Montclair at or below maximum pricing. |
| 10.) 1.5 lt Montclair water at or below maximum pricing | 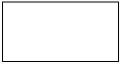 | 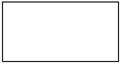 | One (1) point value is given for pricing 1.5 lt Montclair at or below maximum pricing. |
| Pricing Strategy Scoring | | | 10 out of 10 = 100% |
| | | | 5 out of 10 = 50% |
| P.O.P. Implementation | | | |
| 11.) Price identification shelf tags used. | 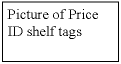 | 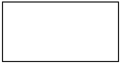 | One (1) point value is given for properly using the Beverage Cooler Price Id. Shelf tags. |
| 12.) Current monthly promotional cooler cling used. | 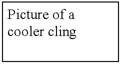 | 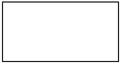 | One (1) point value is given for properly using the current promotional cooler cling. |
| 13.) Current monthly promotional counter sign used. | 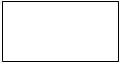 | 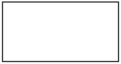 | One (1) point value is given for properly using the current Beverage promotional counter sign. |
| 14.) Current monthly promotional Nozzle Talkers used. | 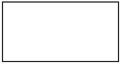 | 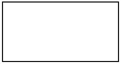 | One (1) point value is given for properly using the current Beverage promotional Nozzle Talkers. |
| 15.) Current monthly promotional Pump Toppers used. | 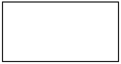 | 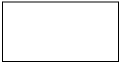 | One (1) point value is given for properly using the current beverage promotional Pump Toppers. |
| P.O.P. Implementation | | | 5 out of 5 = 100% |
| Scoring | | | 3 out of 5 = 60% |
| | | | 1 out of 5 = 20% |
| Planogram | | | |
| Implementation | | | |
| 3.) Maintain Beverage cooler as per planogram. | 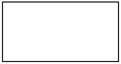 | 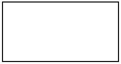 | One (1) point value for each of the 173 facings on planogram so long as each is merchandised in the proper location. |
| Planogram | | | 173 out of 173 = 100% |
| Implementation | | | |
| Scoring | | | |
| Service Level | | | |
| 4.) Maintain an in- stock position of 97% of the 100 SKU's on planogram. | 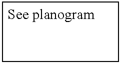 | 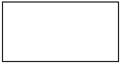 | One (1) point value for each of the 100 SKU's in-stock. Fewer then 6 packs of any SKU is considered out or about to be out of stock. |
| Service Level Scoring | | | 100 out of 100 = 100% |
| Best Practice Retailing Standards | | | Salty Snacks Category |
| Image | | | |
| 5.) Maintain the Hostess display by always keeping the display full and faced. | 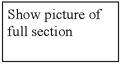 | 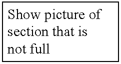 | One (1) point value for each of the 100 facings so long as each facing is al least half filled. |
| Image Scoring | | | 100 out of 100 = 100% |
| Pricing Strategy | | | |
| 6.) Large 319 g Dorito's are priced at or below maximum pricing. | 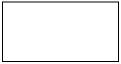 | 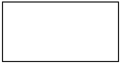 | One (1) point value is given for pricing Large Dorito's at or below maximum pricing. |
| 7.) Large 280 g Ruffles are priced at or below maximum pricing. | 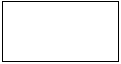 | 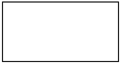 | One (1) point value is given for pricing Large Ruffles at or below maximum pricing. |
| Pricing Strategy Scoring | | | 2 out of 2 = 100% |
| | | | 1 out of 2 = 50% |
| P.O.P. Implementation | | | |
| 16.) Price identification sign used in Take home section. | 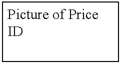 | 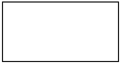 | One (1) point value is given for properly using the Price Id. Signage in the take home section. |
| 17.) Shelf strips used in both the single serve and take home sections. | 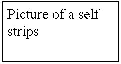 | 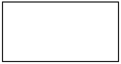 | One (1) point value is given for properly using the shelf strips in both the single serve and take home sections. |
| 18.) Both Big Grab and Mega Grab signs with red frames are properly used. | 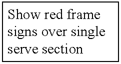 | 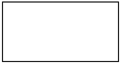 | One (1) point value is given for properly using the red framed sign above the Big Grab and Mega Grab product. |
| 19.) Current monthly promotional counter sign used properly. | 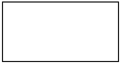 | 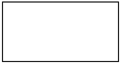 | One (1) point value is given for properly using the current promotional counter sign. |
| 20.) Current monthly promotional Pump Toppers used. | 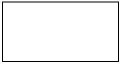 | 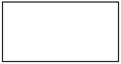 | One (1) point value is given for properly using the current promotional Pump Topper. |
| P.O.P. Implementation | | | 5 out of 5 = 100% |
| Scoring | | | 3 out of 5 = 60% |
| | | | 1 out of 5 = 20% |
| Planogram | | | |
| Implementation | | | |
| 4.) Maintain the single serve and take home section as per planogram. | 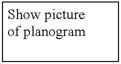 | 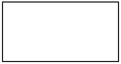 | One (1) point value for each of the 100 facings on planogram so long as each is merchandised in the proper location. |
| Planogram | | | 100 out of 100 = 100% |
| Implementation | | | |
| Scoring | | | |
| Service Level | | | |
| 5.) Maintain an in- stock position of the top 10 Hostess SKU's. | 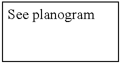 | 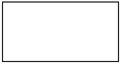 | One (1) point value for each of the 10 SKU's in-stock. Fewer then 3 packs of any SKU is considered out or about to be out of stock. |
| Service Level Scoring | | | 10 out of 10 = 100% |
| Best Practice Retailing Standards | | | Single Serve Category |
| Image | | | |
| 6.) Maintain freshness of product by checking expiration dates on products regularly. Remove outdated product from the shelf. | 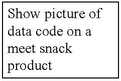 | 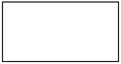 | One (1) point value for each of the 66 SKU's so long as the each SKU is faced up and none of the product is expired, soiled, or opened |
| 7.) Maintain the Single serve section by always keeping the product packaging clean, unopened, full and faced up. | 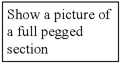 | 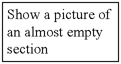 | |
| Image Scoring | | | 66 out of 66 = 100% |
| Pricing Strategy | | | |
| 8.) Small Pringles at or below maximum pricing. | 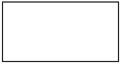 | 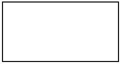 | One (1) point value is given for pricing Small Pringles at or below maximum pricing |
| 3.) Trebor Single serve at of below maximum pricing. | 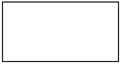 | 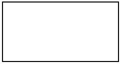 | One (1) point value is given for pricing Trebor single serve product at or below maximum pricing. |
| 4.) Kripry Kernals Tubes at or below maximum pricing. | 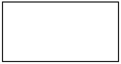 | 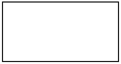 | One (1) point value is given for pricing Krispy Kernals Tube at or below maximum pricing. |
| Pricing Strategy Scoring | | | 2 out of 2 = 100% |
| | | | 1 out of 2 = 50% |
| P.O.P. Implementation | | | |
| 21.) Price identification shelf tags used in front of all SKU's | 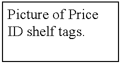 | 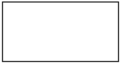 | One (1) point value is given for properly using the Price Id. Shelf tags. |
| 22.) Price tickets used on all pegged product. | 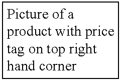 | 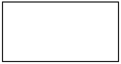 | One (1) point value is given for properly using price tickets on all pegged product. |
| 23.) Both “Snack to Go” signs in red frames properly used above section. | 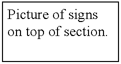 | 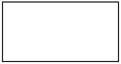 | One (1) point value is given for properly using the “Snacks to Go” signs in red frames on top of section. |
| P.O.P. Implementation | | | 3 out of 3 = 100% |
| Scoring | | | 2 out of 3 = 66.6% |
| | | | 1 out of 3 = 33.3% |
| Planogram | | | |
| Implementation | | | |
| 5.) Maintain Single Serve section as per planogram. | 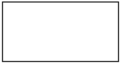 | 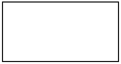 | One (1) point value for each of the 81 items on planogram so long as each item is merchandised in the proper location. |
| Planogram | | | 81 out of 81 = 100% |
| Implementation | | | |
| Scoring | | | |
| Service Level | | | |
| 6.) Maintain an in- stock position of 97% of the 66 SKU's on planogram. | 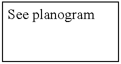 | 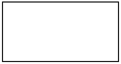 | One (1) point value for each of the 66 SKU's in-stock. Fewer then 3 packs of any SKU is considered out or about to be out of stock. |
| Service Level Scoring | | | 66 out of 66 = 100% |
| Best Practice Retailing Standards | | | Take Home Category |
| Image | | | |
| 8.) Maintain freshness of product by checking expiration dates on products regularly. Remove outdated product from the shelf. | 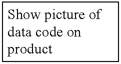 | 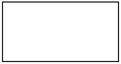 | One (1) point value for each of the 52 SKU's so long as the products for each SKU are faced up and not expired, soiled, or opened. |
| 9.) Maintain the Take Home section by always keeping the product faced up clean and unopened | 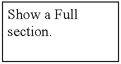 | 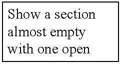 | |
| Image Scoring | | | 52 out of 52 = 100% |
| Pricing Strategy | | | |
| Trebor take home size at or below maximum pricing. | 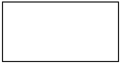 | 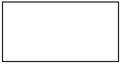 | One (1) point value is given for pricing Trebor take home at or below maximum pricing. |
| 3.) Allan SuperPak at or below maximum pricing. | 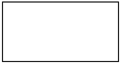 | 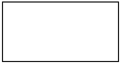 | One (1) point value is given for pricing Allan SuperPak at or below maximum pricing. |
| 4.) Large Pringles at or below maximum pricing. | 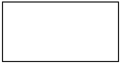 | 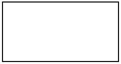 | One (1) point value is given for pricing Large Pringles at or below maximum pricing. |
| Pricing Strategy Scoring | | | 3 out of 3 = 100% |
| P.O.P. Implementation | | | |
| 24.) Price ID shelf tags used in front of all products on shelf. | 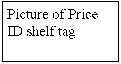 | 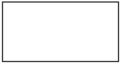 | One (1) point value is given for properly using Price Id. Shelf tags in front of all products on shelf. |
| 25.) Price tickets used on the top right hand corner of all pegged product. | 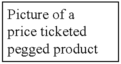 | 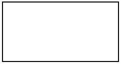 | One (1) point value is given for properly using price tickets on all pegged product. |
| P.O.P. Implementation | | | 2 out of 2 = 100% |
| Scoring | | | |
| Planogram | | | |
| Implementation | | | |
| 6.) Maintain Take Home section as per planogram. | 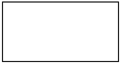 | 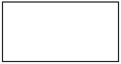 | One (1) point value for each of the 58 facings on planogram so long as each item is merchandised in the proper location. |
| Planogram | | | 58 out of 58 = 100% |
| Implementation | | | |
| Scoring | | | |
| Service Level | | | |
| 7.) Maintain an in- stock position of 97% of the 49 SKU's on planogram. | 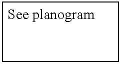 | 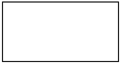 | One (1) point value for each of the 49 SKU's in-stock. Fewer then 3 packs of any SKU is considered out or about to be out of stock. |
| Service Level Scoring | | | 49 out of 49 = 100% |
| Best Practice Retailing Standards | | | Automotive Category |
| Image | | | |
| 10.) Maintain the Automotive section by always keeping the product face- up, and clean. | 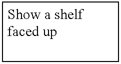 | 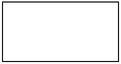 | One (1) point value for each of the 162 facing so long as the face-up and not soiled. |
| Image Scoring | | | 162 out of 162 = 100% |
| Pricing Strategy | | | |
| 9.) Current retailer pricing to be followed. | 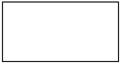 | 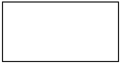 | One (1) point value is given for pricing all retail product at current retailer pricing. |
| 10.) Current WWAF pricing to be followed. | 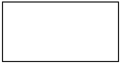 | 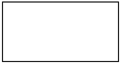 | One (1) point value is given for pricing WWAF at the current retailer price.. |
| 4.) Current Formula 1 10W-30 pricing to be followed. | 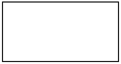 | 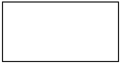 | One (1) point value is given for pricing 10W-30 at the current retailer price. |
| 5.) Current Quaker State 10W-30 pricing to be followed. | 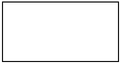 | 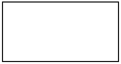 | One (1) point value is given for pricing Quaker State 10W-30 at the current retailer price. |
| Pricing Strategy Scoring | | | 4 out of 4 = 100% |
| | | | 3 out of 4 = 75% |
| | | | 2 out of 4 = 50% |
| | | | 1 out of 4 = 25% |
| P.O.P. Implementation | | | |
| 26.) Price identification shelf tags to be used in front of all products on shelves. | 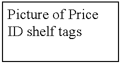 | 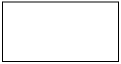 | One (1) point value is given for properly using the Price Id. Shelf tags in front of all products on shelf. |
| 27.) Price tickets to be used on the top right hand corner of all pegged product. | 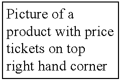 | 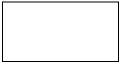 | One (1) point value is given for properly using price tickets on all pegged products. |
| P.O.P. Implementation | | | 2 out of 2 = 100% |
| Scoring | | | |
| Planogram | | | |
| Implementation | | | |
| 7.) Maintain 8 Ft Automotive section as per planogram. | 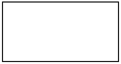 | 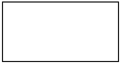 | One (1) point value for each of the 163 facings on planogram so long as each item is merchandised in the proper location. |
| Planogram | | | 75 out of 75 = 100% |
| Implementation | | | |
| Scoring | | | |
| Service Level | | | |
| 8.) Maintain an in- stock position of 97% of the 158 SKU's on planogram. | 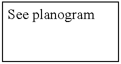 | 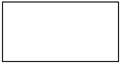 | One (1) point value for each of the 158 SKU's in-stock. Fewer then 2 packs of any SKU is considered out or about to be out of stock. |
| Service Level Scoring | | | 158 out of 158 = 100% |
| Best Practice Retailing Standards | | | Dairy Category |
| Image | | | |
| 11.) Maintain freshness of product by checking expiration dates on products regularly. Remove outdated product from the shelf. | 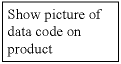 | 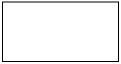 | One (1) point value for each of the 18 SKU's so long as the product is faced-up, clean, unopened and not expired. |
| 12.) Maintain the Dairy display by always keeping the products faced-up, clean and unopened. | 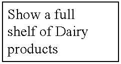 | 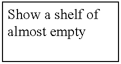 | |
| Image Scoring | | | 18 out of 18 = 100% |
| Pricing Strategy | | | |
| 1.) 500 ml milk in cartons at or below maximum pricing. | 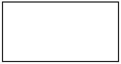 | 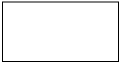 | One (1) point value is given for pricing 500 ml milk in cartons at or below maximum pricing. |
| 2.) 400 ml milk shakes in cartons at or below maximum pricing. | 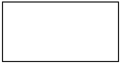 | 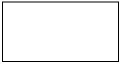 | One (1) point value is given for pricing 400 ml milkshakes at or below maximum pricing. |
| 3.) 500 ml milk in bottles at or below maximum pricing. | 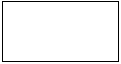 | 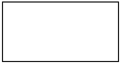 | One (1) point value is given for pricing 500 ml milk in bottles at or below maximum pricing. |
| 4.) 1. lt milk in cartons at or below maximum pricing. | 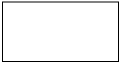 | 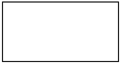 | One (1) point value is given for pricing 1 lt milk in cartons at or below maximum pricing. |
| Pricing Strategy Scoring | | | 4 out of 4 = 100% |
| P.O.P. Implementation | | | |
| 28.) Price identification shelf tags used in front of all product. | 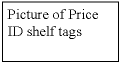 | 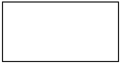 | One (1) point value is properly using the Price Id. Shelf tags in front of products with different price points. |
| P.O.P. Implementation | | | 1 out of 1 = 100% |
| Scoring | | | |
| Planogram | | | |
| Implementation | | | |
| 8.) Maintain the Dairy section as per planogram. | 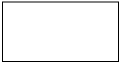 | 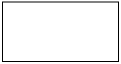 | One (1) point value for each of the 21 facings on planogram so long as each item is merchandised in the proper location. |
| Planogram | | | 21 out of 21 = 100% |
| Implementation | | | |
| Scoring | | | |
| Service Level | | | |
| 9.) Maintain an in- stock position of 97% of the 11 SKU's on planogram. | 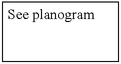 | 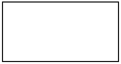 | One (1) point value for each of the 11 SKU's in-stock. Fewer then 2 units of any SKU is considered out or about to be out of stock. |
| Service Level Scoring | | | 11 out of 11 = 100% |
| Best Practice Retailing Standards | | | Deli Sandwich Category |
| Image | | | |
| 13.) Maintain freshness of product by checking expiration dates on products regularly. Remove outdated product from the shelf. | 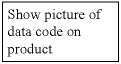 | 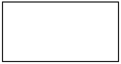 | One (1) point value for each of the 6 SKU's so long as the packages for each SKU are not expired, soiled, or opened |
| 14.) Maintain the Deli Sandwich section by always keeping the product packaging clean and unopened | 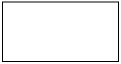 | 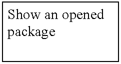 | |
| Image Scoring | | | 6 out of 6 = 100% |
| Pricing Strategy | | | |
| 11.) Follow supplier suggested pricing. | 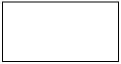 | 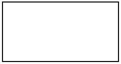 | One (1) point value is given for each of the 6 SKU that are priced at the suppliers suggested pricing. |
| 12.) Have one specially priced sandwich. | 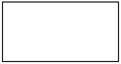 | 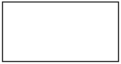 | One (1) point value is given for specially pricing one sandwich. |
| Pricing Strategy Scoring | | | 7 out of 7 = 100% |
| P.O.P. Implementation | | | |
| 29.) Price tickets on the top right hand corner of all product. | 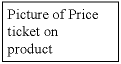 | 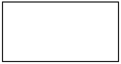 | One (1) point value is given for properly using price tickets on each of the 6 SKU's.. |
| 30.) Special red price ticket used to indicate one sandwich on special. | 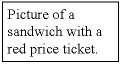 | 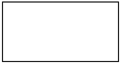 | One (1) point value is given for properly using a special red price ticket to indicate one sandwich on special.. |
| 4.) Use at least one price id shelf tags to identify one $2.99 shelf of sandwiches. | 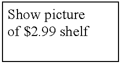 | 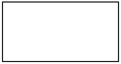 | One (1) point value given for properly using price id. Shelf tag to identify one shelf of $2.99 sandwiches. |
| P.O.P. Implementation | | | 8 out of 8 = 100% |
| Scoring | | | |
| Planogram | | | |
| Implementation | | | |
| 9.) Maintain 2 shelves of sandwiches as per planogram. | 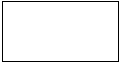 | 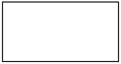 | One (1) point value for maintaining 2 shelves of sandwiches, |
| 2.) Maintain one of the 2 shelves for $2.99 sandwiches. | 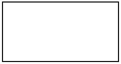 | 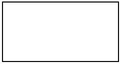 | One (1) point value for maintaining 1 shelf of $2.99 sandwiches. |
| Planogram | | | 2 out of 2 = 100% |
| Implementation | | | |
| Scoring | | | |
| Service Level | | | |
| 10.) Have a minimum of 12 sandwiches in stock at all times. | 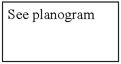 | 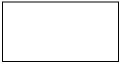 | One (1) point value for each of the 12 sandwiches in stock |
| 2.) Have a minimum of 6 sandwiches at a $2.99 price point in stock at all times. | 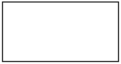 | 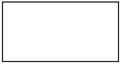 | One (1) point value for each of the 6 sandwiches in stock with a $2.99 price point. |
| Service Level Scoring | | | 18 out of 18 = 100% |
| Best Practice Retailing Standards | | | Chocolate Bar Category |
| Image | | | |
| 15.) Maintain freshness of product by checking expiration dates on products regularly. Remove outdated product from the shelf. | 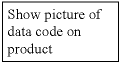 | 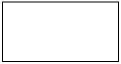 | One (1) point value for each of the 44 SKU's so long as the packages for each SKU are not expired, soiled, or opened |
| 16.) Maintain the Chocolate Bar display by always keeping the product packaging clean and unopened | 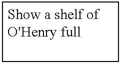 | 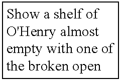 | |
| Image Scoring | | | 44 out of 44 = 100% |
| Pricing Strategy | | | |
| 13.) Regular Bars at or below maximum pricing. | 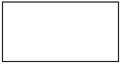 | 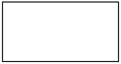 | One (1) point value is given for pricing Regular gum at or below maximum pricing. |
| 14.) King Size Bars at or below maximum pricing. | 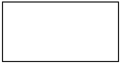 | 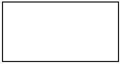 | One (1) point value is given for pricing Premium gum at or below maximum pricing. |
| Pricing Strategy Scoring | | | 2 out of 2 = 100% |
| | | 1 out of 2 = 50% | |
| P.O.P. Implementation | | | |
| 31.) Price identification sign used. | 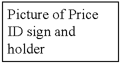 | 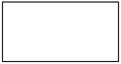 | One (1) point value is given for properly using the Chocolate Bar Price Id. sign and holder. |
| 32.) Current monthly promotional shelf dangler used. | 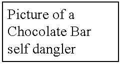 | 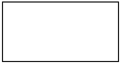 | One (1) point value is given for properly using the current Chocolate Bar promotional shelf dangler. |
| 33.) Current monthly promotional counter sign used. | 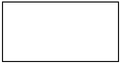 | 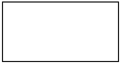 | One (1) point value is given for properly using the current Chocolate Bar promotional counter sign. |
| 34.) Current monthly promotional Nozzle Talkers used. | 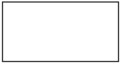 | 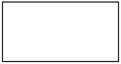 | One (1) point value is given for properly using the current Chocolate Bar promotional Nozzle Talkers. |
| 35.) Current monthly promotional Pump Toppers used. | 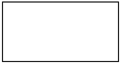 | 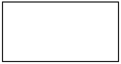 | One (1) point value is given for properly using the current Chocolate Bar promotional Pump Topper. |
| P.O.P. Implementation | | | 5 out of 5 = 100% |
| Scoring | | | |
| Planogram | | | |
| Implementation | | | |
| 10.) Maintain Chocolate Bar section as per planogram. | 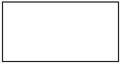 | 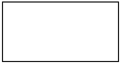 | One (1) point value for each of the 57 items on planogram so long as each item is merchandised in the proper location. |
| Planogram | | | 75 out of 75 = 100% |
| Implementation | | | |
| Scoring | | | |
| Service Level | | | |
| 11.) Maintain an in- stock position of 97% of the 44 SKU's on planogram. | 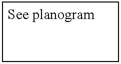 | 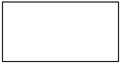 | One (1) point value for each of the 44 SKU's in-stock. Fewer then 6 packs of any SKU is considered out or about to be out of stock. |
| Service Level Scoring | | | 44 out of 44 = 100% |
| Image | | | |
| 17.) Maintain freshness of product by checking expiration dates on products regularly. Remove outdated product from the shelf. | 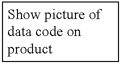 | | One (1) point value for each of the 44 SKU's so long as the packages for each SKU are not expired, soiled, or opened |
| 18.) Maintain the Chocolate Bar display by always keeping the product packaging clean and unopened | 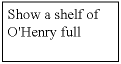 | 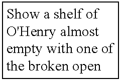 | |
| Image Scoring | | | 44 out of 44 = 100% |
| Pricing Strategy | | | |
| 15.) Regular bars at or | | | One (1) point value is |
| below maximum | | | given for pricing |
| pricing. | | | Regular gum at or |
| | | | below maximum |
| | | | pricing. |
| 16.) King Size Bars at or | | | One (1) point value is |
| below maximum | | | given for pricing |
| pricing. | | | Premium gum at or |
| | | | below maximum |
| | | | pricing. |
| Pricing Strategy Scoring | | | 2 out of 2 = 100% |
| | | | 1 out of 2 = 50% |
| P.O.P. Implementation | | | |
| 36.) Price identification sign used. | 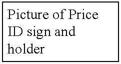 | | One (1) point value is given for properly using the Chocolate Bar Price Id. sign and holder. |
| 37.) Current monthly promotional shelf dangler used. | 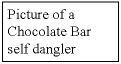 | | One (1) point value is given for properly using the current Chocolate Bar promotional shelf dangler. |
| 38.) Current monthly | | | One (1) point value is |
| promotional | | | given for properly |
| counter sign used. | | | using the current |
| | | | Chocolate bar |
| | | | promotional counter |
| | | | sign. |
| 39.) Current monthly | | | One (1) point value is |
| promotional | | | given for properly |
| Nozzle Talkers | | | using the current |
| used. | | | Chocolate Bar |
| | | | promotional Nozzle |
| | | | Talkers. |
| 40.) Current monthly | | | One (1) point value is |
| promotional | | | given for properly |
| Pump Toppers | | | using the current |
| used. | | | Chocolate Bar |
| | | | promotional Pump |
| | | | Topper. |
| P.O.P. Implementation | | | 5 out of 5 = 100% |
| Scoring | | | 3 out of 5 = 60% |
| | | | 1 out of 5 = 20% |
| Planogram | | | |
| Implementation | | | |
| 11.) Maintain | | | One (1) point value for |
| Chocolate Bar | | | each of the 57 items |
| section as per | | | on planogram so long |
| planogram. | | | as each item is |
| | | | merchandised in the |
| | | | proper location. |
| Planogram | | | 75 out of 75 = 100% |
| Implementation | | | |
| Scoring | | | |
| Service Level | | | |
| 12.) Maintain an in- stock position of 97% of the 44 SKU's on planogram. | 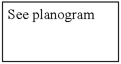 | | One (1) point value for each of the 44 SKU's in-stock. Fewer then 6 packs of any SKU is considered out or about to be out of stock. |
| Service Level Scoring | | | 44 out of 44 = 100% |
| Image | | | |
| 19.) Maintain freshness of product by checking expiration dates on products regularly. Remove outdated product from the shelf. | 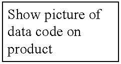 | | One (1) point value for each of the 44 SKU's so long as the packages for each SKU are not expired, soiled, or opened |
| 20.) Maintain the Chocolate Bar display by always keeping the product packaging clean and unopened | 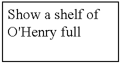 | 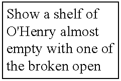 | |
| Image Scoring | | | 44 out of 44 = 100% |
| Pricing Strategy | | | |
| 17.) Regular bars at or | | | One (1) point value is |
| below maximum | | | given for pricing |
| pricing. | | | Regular gum at or |
| | | | below maximum |
| | | | pricing. |
| 18.) King Size Bars at or | | | One (1) point value is |
| below maximum | | | given for pricing |
| pricing. | | | Premium gum at or |
| | | | below maximum |
| | | | pricing. |
| Pricing Strategy Scoring | | | 2 out of 2 = 100% |
| | | 1 out of 2 = 50% | |
| P.O.P. Implementation | | | |
| 41.) Price identification sign used. | 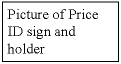 | | One (1) point value is given for properly using the Chocolate Bar Price Id. sign and holder. |
| 42.) Current monthly promotional shelf dangler used. | 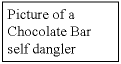 | | One (1) point value is given for properly using the current Chocolate Bar promotional shelf dangler. |
| 43.) Current monthly | | | One (1) point value is |
| promotional | | | given for properly |
| counter sign used. | | | using the current |
| | | | Chocolate Bar |
| | | | promotional counter |
| | | | sign. |
| 44.) Current monthly | | | One (1) point value is |
| promotional | | | given for properly |
| Nozzle Talkers | | | using the current |
| used. | | | Chocolate Bar |
| | | | promotional Nozzle |
| | | | Talkers. |
| 45.) Current monthly | | | One (1) point value is |
| promotional | | | given for properly |
| Pump Toppers | | | using the current |
| used. | | | Chocolate Bar |
| | | | promotional Pump |
| | | | Topper. |
| P.O.P. Implementation | | | 5 out of 5 = 100% |
| Scoring | | | 3 out of 5 = 60% |
| | | | 1 out of 5 = 20% |
| Planogram | | | |
| Implementation | | | |
| 12.) Maintain | | | One (1) point value for |
| Chocolate Bar | | | each of the 57 items |
| section as per | | | on planogram so long |
| planogram. | | | as each item is |
| | | | merchandised in the |
| | | | proper location. |
| Planogram | | | 75 out of 75 = 100% |
| Implementation | | | |
| Scoring | | | |
| Service Level | | | |
| 13.) Maintain an in- stock position of 97% of the 44 SKU's on planogram. | 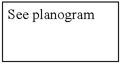 | | One (1) point value for each of the 44 SKU's in-stock. Fewer then 6 packs of any SKU is considered out or about to be out of stock. |
| Service Level Scoring | | | 44 out of 44 = 100% |

What is claimed is:

1. A method for merchandise management for a plurality of merchandise and supporting marketing material, comprising the steps of:
Selecting a plurality of primary merchandising tasks;
Paraphrasing each of the plurality of primary merchandising tasks for at least one of the plurality of merchandise into at least one sub merchandising task, forming a set of sub merchandising tasks;
Combining the set of sub merchandising tasks into a standards manual; and
Conducting a check-and-assessment of the plurality of merchandise using the set of sub merchandising tasks.

2. The method of claim 1, wherein the plurality of primary merchandising tasks comprises Product Placement/Planogramming, Product Pricing, Product Availability/Service Levels, Product Promotion/P.O.P. Implementation, and Product Image/Freshness.

3. The method of claim 1, further comprising the step of using results from the check-and-assessment for evaluating performance of at least one person responsible for display of said merchandise.

4. The method of claim 3, wherein evaluating performance of the at least one person responsible for display of said merchandise comprises the user performing sub merchandising tasks and determining the percentage of affirmative replies.

5. The method of claim 1, further comprising the step of using results from the check-and-assessment for generating a list of further things to do for merchandise management.

6. The method of claim 1, further comprising the step of using results from the check-and-assessment for generating a list of further things to do to complete merchandise management.

7. The method of claim 1, further comprising the step of using results from the check-and-assessment for printing P.O.P. or shelf price tags identified to be missing.

8. The method of claim 1, further comprising the step of using results from the check-and-assessment for generating a printed or electronic inventory order.

9. The method of claim 1, wherein the a set of sub merchandising tasks involve the use of at least one planogram.

10. The method of claim 1, wherein the check-and-assessment of the plurality of merchandise comprises the steps of:
Performing at least one sub merchandising task of the set of sub merchandising tasks; and
Recording the result of the at least one sub merchandising task.

11. The method of claim 1, wherein:
the step of combining the set of sub merchandising tasks into a standards manual comprises storing the sub merchandising tasks in a storage of a computer, wherein the computer comprises a processor, memory, further storage, and communication facilities;
and the step of conducting a check-and-assessment of the plurality of merchandise using the sub merchandising tasks comprises using a speaker element in electronic communication with the computer for providing a first voice information to the user from the computer and a microphone element in electronic communication with the computer for receiving a second voice information from the user and transmitting said second voice information in electronic form to the computer.

12. A voice interactive system for assisting a user to manage merchandise for a plurality of merchandise and supporting marketing material, comprising:
A computer, comprising a processor, memory, storage, and communication facilities;
A speaker element in electronic communication with the computer for providing a first voice information to the user from the computer;
A microphone element in electronic communication with the computer for receiving a second voice information from the user and transmitting said second voice information in electronic form to the computer;
A file or database containing a plurality of sub merchandising tasks; and
Software stored at the computer for performing the steps assisting the user to conduct a check-and-assessment, the steps comprising:
Retrieving a sub merchandising task from the file or database;
Communicating the sub merchandising task to the user using the speaker element;
Receiving a response to the sub merchandising task from the user using the microphone element; and
Processing said response.

13. The system of claim 12, wherein the plurality of sub merchandising tasks are paraphrases of a plurality of primary merchandising tasks for the plurality of merchandise, including Product Placement/Planogramming, Product Pricing, Product Availability/Service Levels, Product Promotion/P.O.P. Implementation, and Product Image/Freshness.

14. The system of claim 12, wherein the check-and-assessment is used for evaluating performance of at least one person responsible for display of said plurality of merchandise.

15. The system of claim 14, wherein evaluating performance of the at least one person responsible for display of said merchandise comprises the user performing sub merchandising tasks and determining the percentage of affirmative replies.

16. The method of claim 12, further comprising the step of using results from the check-and-assessment for generating a list of further things to do for merchandise management.

17. The method of claim 12, further comprising the step of using results from the check-and-assessment for generating a list of further things to do to complete merchandise management.

18. The method of claim 12, further comprising the step of using results from the check-and-assessment for printing P.O.P. or shelf price tags identified to be missing.

19. The method of claim 12, further comprising the step of using results from the check-and-assessment for generating a printed or electronic inventory order.

20. The system of claim 12, further comprising an electronic display for presenting the content of at least one planogram.

21. The system of claim 12, wherein the check-and-assessment of the plurality of merchandise comprises the steps of:
Performing at least one sub merchandising task of the set of sub merchandising tasks; and
Recording the result of the at least one sub merchandising task.

22. The system of claim 12, wherein a headset comprises the speaker element and the headphone element for allowing the check-and-assessment to be conducted by the user hands-free.

23. The system of claim 12, wherein the software comprises a speech recognition component for the step of receiving the response to the sub merchandising task from the user.
